(19) United States
(12) Patent Application Publication
(10) Pub. No.: US 2002/0066830 A1
(43) Pub. Date: Jun. 6, 2002

(54) Vibrational air mover (V. A. M. )

(76) Inventors: Lester Earl Mullings JR., Springfield, OR (US); Lester Earl Mullings SR., Quincy, WA (US)

Correspondence Address: Lester Earl Mullings Jr, 733 Mill St Apt 9, Springfield, OR, 97477, US

(21) Appl. No.: 09/727,735

(22) Filed: Dec. 4, 2000

Related U.S. Application Data
(60) Provisional application No. 60/172,789, filed on Dec. 21, 1999.

(51) Int. Cl. B64C 3/00

(52) U.S. Cl. 244/198

(57) ABSTRACT

Disclosed herein is a vibrational air mover that is open on both ends with eye shaped openings. There is a cable pulled tight from corner to corner of the eye shaped openings on both ends. The two eye shaped pieces are connected to each other with iron rods, the rods connect to the corners of the eye shaped pieces. This forms a rectangular shape with openings on each end. There is a cable running from corner to corner of the eye shaped openings, connecting to the center of these two cables is an additional cable that runs the length of the air mover. The eye shaped pieces are made of a flexable material, such as stainlesss steal. The frame work is then covered with material rip stop nylon is sewn to the eye shaped pieces and the iron rods it needs to be pulled tight as it is sewn on. Then the material is doped with air craft dope or butyrate dope to pull the material drum tight. Then the weight bearing cable is attached, it is attached to the front eye shaped piece in the center of the cable. The weight bearing cable has a weight attached at the half way point between the handle or lever and the front eye shaped opening. When the weight bear bearing cable comes tight it goes into a state of vibration, the vibration releases friction inside the air mover allowing the air inside the air mover to move freer. The air mover is placed inside the wing of the air craft, the wing has openings on the top of the wing that allows air to pulled inside the wing, there are also openings on the bottom of the wing to allow air to escape or leave the wing. The vibration moves the eye shaped pieces slightly opening and closing them, this causes small volumes of air to move down the air mover, although the volumes being moved are small due to the fact that they are being caused by the vibration means that there are many small volumes of air bieng moved, and at a rapid and repitious rate, this coupled with the release of friction and the fact that once the vibration begins as far as the air outside of the wing of the air craft is concerned there is an inbalance taking place the air inside the wing of the air craft is lacking in volume or in a state of vacuum, and the air outside rushes in to fill the vacuum or void, to try to balance the two volumes of air. This is how a large amount of air can be moved in a short period of time and with a minimal amount of effort.

### CROSS-REFERENCE APPLICATION

Not Applicable

### STATEMENT REGARDING FEDERALLY SPONSORED RESEARCH OR DEVELPOMENT

Not Applicable

### REFERENCE TO A MICROFICHE APPENDIX

Not Applicable

### BACKGROUND OF THE INVENTION

This invention pertains to the technical field of physics as it relates to the movement of large masses of air with a minimal amount of physical effort, for the purpose of man powered flight. This is accomplished with a combination of leverage, vibration, and volumetric change. First the leverage used is the lever or handle pulled to bring the weight bearing cable tight. Second is the vibration that is a result of the weight bearing cable comming tight setting the vibrational air mover into motion. The volumetric change is as well a result of the weight bearing cable comming tight, when this happens the vibation is set into motion causing the air mover to open and close slightly resulting in small volumetric changes to take place.

When the vibration begins it releases friction inside the air mover allowing the air to move more freely, and due to the fact that the air mover is inside the wing of the air craft is important in that the air inside the wing goes into a state of vibration as well. The air outside the wing tries to rush in to fill what it sees as a vacuum or imbalance between the to volumes of air.

### BRIEF SUMMARY OF THE INVENTION

This invention is directed to the futherance of man powered flight. This is best accomplished by maximumizing the amount of work being done, while minimizing the amount of effort being applied. This is accomplished with a combination of vibration, leverage and volumetric change.

The volumetric changes taking place inside the air mover are a direct result of the vibration induced when the weight bearing cable comes tight. The second effect of the vibration is a release of friction on the air inside the air mover, this allows the air to move more freely once the vibration is set into motion. The vibration caused when the weight bearing cable comes tight opens and closes the front eye shaped opening of the air mover slightly, and this sets small volumes of air into motion. Although the volumes of air being set into motion are small, due to the frequency and repitition means that many small volumes of air can be moved in a short period of time allowing you to move a large amount of air in a minimal amount of time.

The leverage used in this invention is the lever or handle pulled, that brings the weight bearing cable tight. Once the weight bearing cable comes tight the vibration releases the friction on the surface inside the air mover so that the air that is resting on the surface inside the air mover now has no solid surface to rest on, this releases the friction allowing the air to move more freely.

### BRIEF DESCRIPTION OF THE SEVERAL VIEWS OF THE DRAWING

FIG. 1 is a front view of the air mover. This view shows the basic shape of the air mover, and how the cables are attached to each other as well as how the cables attach to the air mover. This view also shows the weight bearing cable and how it is attached to the air mover.

FIG. 2 is the top view of the air mover it shows the outter covering of the air mover, the basic shape of the air mover and the where the frame work inside the a tables to the four corners of the air mover.

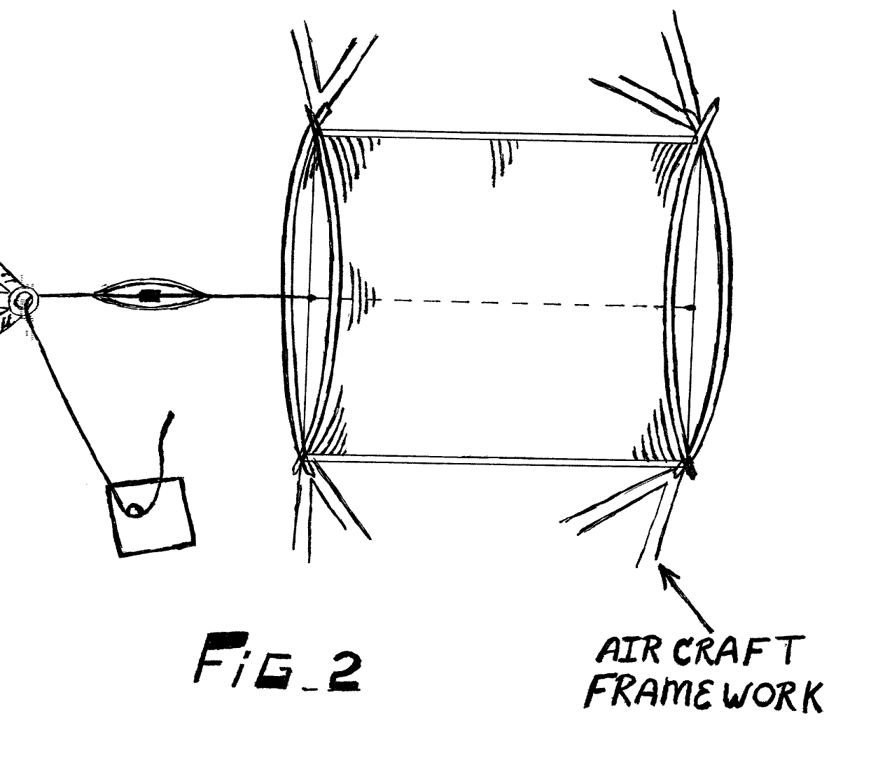

FIG. 3 is a side view of the air mover, showing the basic shape of the air mover and how the cables are attached to the air mover.

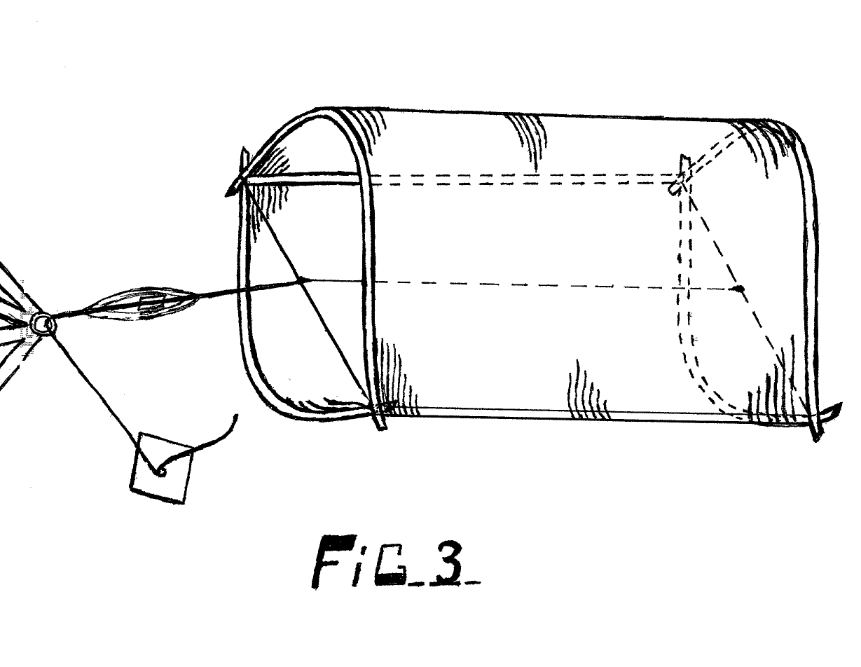

FIG. 4 is a cut away of the wing of the air craft that shows the air inlets on top of the wing as well as the air outlets on the bottom of the wing. This view also shows the air movers inside the wing and the frame work of the wing and where it attaches to the four corners of the air mover. This view has some of the air movers parts labled to clairify the drawing.

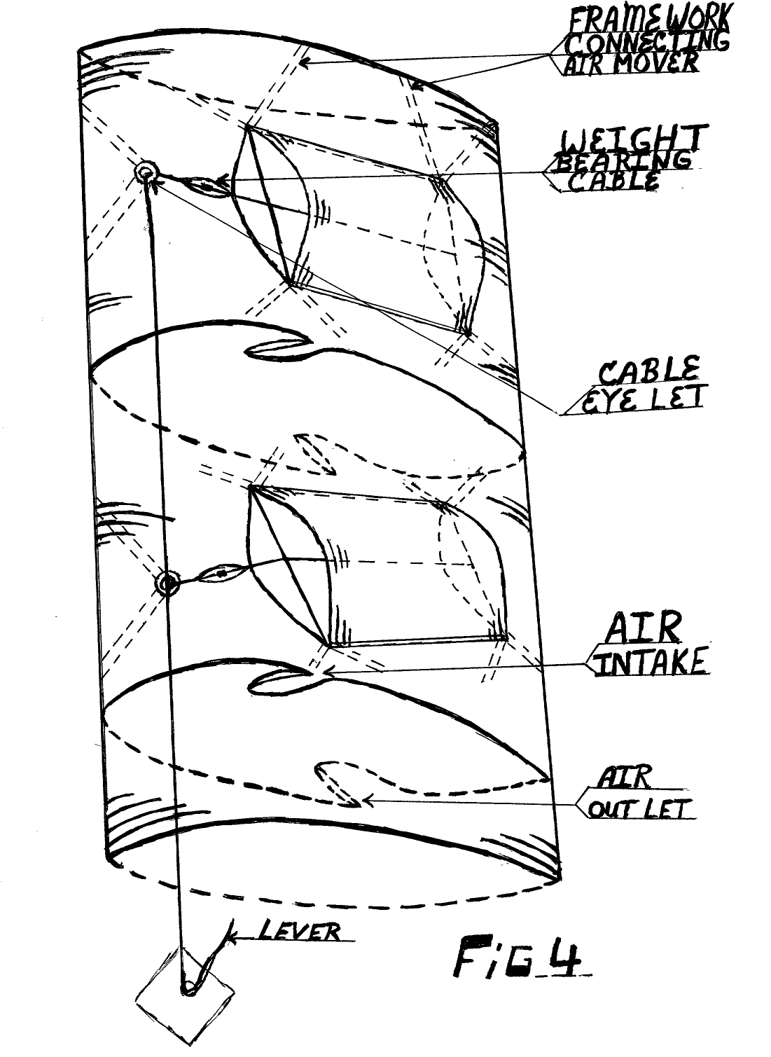

### DETAILED DESCRIPTION OF THE INVENTION

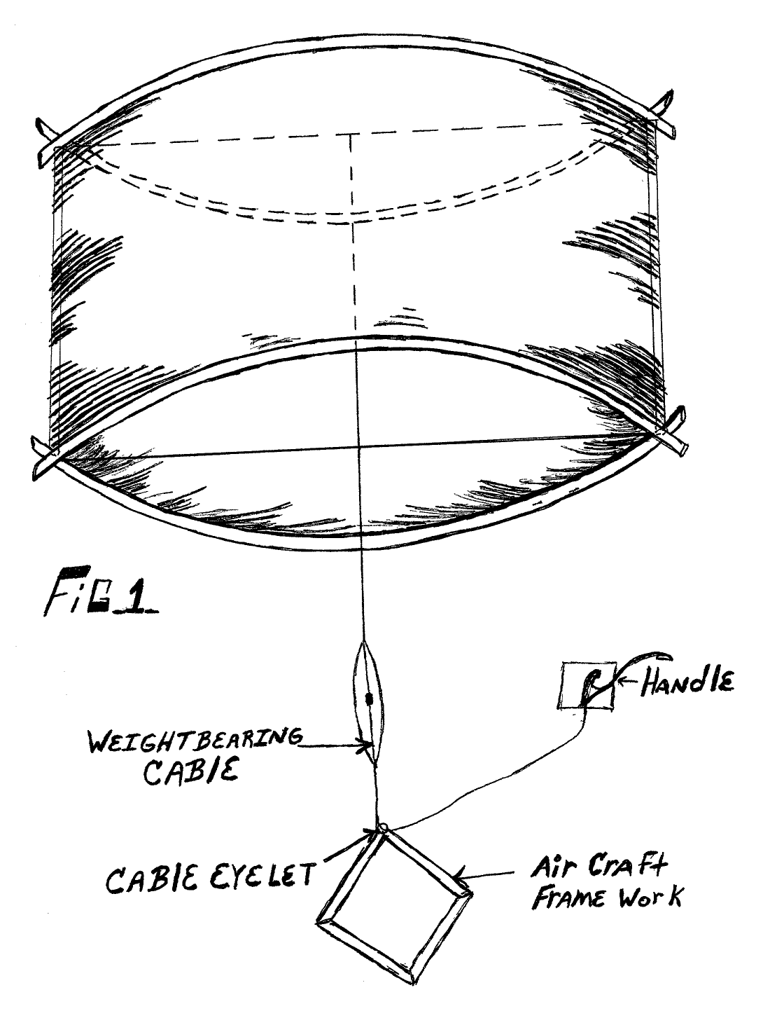

Refering to FIG. 1. This is a vibrational air mover, its purpose is to move large amounts of air with a minimal amount of effort. The intention of the air mover is to make a man powered air mover that can move a large amount of air with a minimal amount of effort, for the purpose of making man powered flight efficant in that you gain the most amount of work with the minimal effort.

The air mover consists of an air bellows that has two eye shaped pieces made of a material that is flexable and strong stainless steal is what the two eye shaped pieces are made of in this air bellows. There are two iron rods that connect the eye shaped pieces to each other, this forms a rectangular shape with eye shaped openings on both ends. Running down the center of the eye shaped openings from corner to corner of the eye shaped openings is a cable, the cable is pulled tight holding the eye shaped openings open. Then running down the lenght of the rectangular shape is a cable that is attached in the center of the eye shaped opening to the cables that are pulled tight to hold the eye shaped openings open, or the cables that run from corner to corner of the eye shape. Then there is a cable that is attached to the front eye shaped opening, this is the weight bearing cable, it is connected to the cable in the middle of the eye shaped opening it is connected at the half way point oppisite the cable that runs down the center of the air bellows. The weight bearing cable has a weight located at the half way point between the lever or handle and the front eye shaped piece, this is the cable that goes into vibration when the cable is pulled tight setting the air mover into motion.

Next the covering is put on the frame work, the material rip-stop nylon is then sewn on the frame work, the material is sewn on to the eye shaped pieces and the two iron rods that connect the eye shaped pieces to each other. After the material is sewn on and pulled snug, now it is time to pull the material even tighter by covering the material with air craft dope or butyrate dope. Once the material is covered both inside as well outside let it dry once it is dry it will be wrinkle free and drum tight. Now the airmover is ready to be put inside the wing of the air craft. When the weight bearing cable comes tight it sets the air mover into motion the air both inside the air mover as well as outside of the air mover goes into vibration, and because the air mover is inside the wing of the air craft the volume of air inside the wing is in a state of vibration as well.

Once the vibtation begins the eye shaped openings open and close slightly setting small volumes of air into motion, the vibration at the same time releases friction allowing the air that is set into motion to move more freely, although the volumes of air being moved is small it is being done quickly and repitiously as to set a large amount of air into motion.

The added result of the vibration caused when the weight bearing cable comes tight is that once the air inside the wing is set into vibration, the air outside the wing considers the air inside the wing to be lacking in volume or in a state of vacuum, and the balance between the two volumes of air is no longer balanced and the air rushes in over the wing to try to fill the vacuum and rebalance the two volumes of air.

This is how a large amount of air can be moved with a minimal amount of effort.

We claim:

1. A Vibrational Air Mover (V.A.M.) comprising of an air bellows that is shaped in the shape of an eye on both ends, the eye shapes are connected to each other by two iron rods that are connected to the corners of the eye shaped openings forming a rectangular shape with eye shaped openings on both ends, running through the center of the eye shaped openings is a cable that connects to the corners of the eye shaped openings, on both ends the cables are pulled tight the eye shaped openings are made of a flexable material such as stainless steal, there is as well a cable that runs the lenght of the air mover down the center this cable is connected to the eye shaped openings on both ends.

2. The combination of claim 1 wherein said that there is a cable that runs the length of the air mover is connected to the two cables that are connected to the corners of the eye shaped openings there is as well a cable that is attached to the front eye shaped opening this is the weight bearing cable it is attached to the center of the cable that runs from corner to corner of the front eye shaped opening, it has a weight attached midlength of the cable, the other end of this cable is attached to the handle or lever.

3. The combination of claim 1 wherein the two eye shaped openings are connected by two iron rods resulting in a rectangular shape with eye shaped openings on both ends this is covered with rip-stop nylon sewn to the frame work and doped with butyrate dope to pull the material tight,
The air mover is then placed inside the wing of the air craft, the air mover is then attached by its four corners to the frame work of the wing, the wing has openings on the top of the wing to pull air in, openings on the bottom of the wing allow the air to be released.

4. The combination of claim 1 wherein said that there was a cable running down the center of the air mover, attached outside the air mover is the weight bearing cable it attaches in the center of the front eye shaped opening oppisite the cable running down the center of the air mover, when the weight bearing cable comes tight the cable goes into a state of vibration, the vibration does the work in this air mover it has more than one purpose, first the vibration releases the friction onmthe air both inside the air mover as well as inside the wing of the air craft, this produces an imbalance between the two volumes of air the air outside the wing of the air craft considers the air inside the wing to be lacking in volume or in a state of vacuum, se it moves in to fill the void and try to regain balance, and because the air inside the wing is in a state of vibration allows it to move easier or to be moved with less effort, when the eye shaped openings begin to vibrate it opens and closes the eye shape and although the movement is small and the volumes of air being moved is small because it is done at such a repitisiouslyrate and the friction minimized allows for a large amount of air to be moved while a minimum amount work is applied.
